(19) United States
(12) Patent Application Publication
(10) Pub. No.: US 2012/0031069 A1
(43) Pub. Date: Feb. 9, 2012

(54) COMBINED CYCLE POWER GENERATING DEVICE

(76) Inventor: Takashi MARUYAMA, Tokyo (JP)

(21) Appl. No.: 13/181,892

(22) Filed: Jul. 13, 2011

(30) Foreign Application Priority Data
Jul. 14, 2010 (JP) 2010-159304

(51) Int. Cl. F01K 23/10; F02C 6/18

(52) U.S. Cl. 60/39.182

(57) ABSTRACT

A combined cycle power generating device in which the exhaust heat of the gas turbine reheats the steam discharged out of the high pressure chamber of the steam turbine so that the reheated steam is supplied to the intermediate-pressure chamber in order to increase the power output of the steam turbine, wherein the cooling steam that has cooled the gas turbine is supplied to the intermediate-pressure chamber via a cooling steam inlet different from the inlet of the reheat steam that is reheated by the exhaust heat of the gas turbine, so that the cooling steam is used for cooling purpose, the temperature of the cooling steam being higher than the temperature of the steam discharged out of the high pressure chamber.

### BACKGROUND OF THE INVENTION

1. Field of the Invention

The present invention relates to a combined cycle power generating device in which the steam discharged from a high-pressure chamber of a steam turbine is reheated by the exhaust heat of the exhaust gas emitted from a gas turbine so that the reheated steam is supplied to an intermediate-pressure chamber of the steam turbine and used to promote the drive of the steam turbine; the present invention especially relates to a combined cycle power generating device in which the turbine rotor in the intermediate-pressure chamber can be effectively cooled.

2. Background of the Invention

The combined cycle power generating device in which at least one gas turbine and at least one steam turbine are combined is previously known. Since the combined cycle power generating device in which the gas turbine and the steam turbine are combined efficiently generates electric power in a manner that the exhaust heat of the gas turbine promotes the power generation of the steam turbine, the fuel consumption and the CO₂ generation are kept low; accordingly, the demand for the combined power generating device is expanding in recent years.

In the combined cycle power generating device, the exhaust heat of the gas turbine reheats the steam discharged from the high-pressure chamber of the steam turbine and the reheated steam (the reheat steam) is supplied to the intermediate-pressure chamber so that the reheat steam promotes the power generation of the steam turbine.

Further, in the combined cycle power generating device in which the gas turbine and the steam turbine are combined, the temperature of the main steam supplied to the high-pressure turbine of the steam turbine system is almost the same as the temperature of the reheat steam supplied to the intermediate-pressure turbine of the steam turbine system; however, the diameter of the blade in the intermediate-pressure turbine is greater than the diameter of the blade in the high-pressure turbine so that the centrifugal force acting on the blade in in the intermediate-pressure turbine is stronger than the centrifugal force acting on the blade in in the high-pressure turbine, when the steam turbine is operated and the rotor is rotated. Thus, with regard to the creep strength of the turbine rotor and the blade root especially in the periphery of the steam inlet part, a difficulty to be settled arises. Hence, it becomes necessary to cool the turbine rotor in the intermediate-pressure turbine of the combined cycle power generating device.

FIG. 4 illustrates the cooling method regarding the turbine rotor in the intermediate-pressure turbine of the conventional combined cycle power generating device; thereby, FIG. 4 shows the periphery of the steam inlet of the high-pressure turbine as well as the periphery of the steam inlet of the intermediate-pressure turbine regarding the steam turbine in the combined cycle power generating device.

The steam turbine system 03 is provided with the intermediate-pressure turbine 2 and the high-pressure turbine 4. The intermediate-pressure turbine 2 is provided with a plurality of stator cascades. A plurality of stator blades 24a forms the first stage stator cascade; a plurality of stator blades 24b forms the second stage stator cascade; a plurality of stator blades 24c forms the third stage stator cascade, . . . , and so on. Hereby, the intermediate-pressure turbine 2 is further provided with an intermediate-pressure turbine casing 22 that supports the roots 23a and tips 23b of the stator blades 24a regarding the first stage stator cascade; in addition, the intermediate-pressure turbine casing 22 supports the roots 23a of the stator blades 24b, 24c, . . . regarding the second stage stator cascade and the following stage stator cascades. The intermediate-pressure turbine 2 is further provided with a plurality of rotor cascades. A plurality of rotor blades 26a forms the first stage rotor cascade; a plurality of rotor blades 26b forms the second stage rotor cascade; a plurality of rotor blades 26c forms the third stage rotor cascade, . . . , and so on.
On the other hand, the high-pressure turbine 4 is provided with a plurality of stator cascades. A plurality of stator blades 44a forms the first stage stator cascade; a plurality of stator blades 44b forms the second stage stator cascade; a plurality of stator blades 44c forms the third stage stator cascade, . . . , and so on. Hereby, the high-pressure turbine 4 is further provided with a high-pressure turbine casing 42 that supports the roots 43a and tips 43b of the stator blades 44a regarding the first stage stator cascade; in addition, the high-pressure turbine casing 42 supports the roots 43a of the stator blades 44b, 44c, . . . regarding the second stage stator cascade and the following stage stator cascades. The high-pressure turbine 4 is further provided with a plurality of rotor cascades. A plurality of rotor blades 46a forms the first stage rotor cascade; a plurality of rotor blades 46b forms the second stage rotor cascade; a plurality of rotor blades 26c forms the third stage rotor cascade, . . . , and so on.

Further, a reheat steam inlet 3 is provided so that the reheat steam is supplied to the intermediate-pressure turbine 2 through the inlet 3; in addition, a main steam inlet 5 is provided so that the main steam is supplied to the high-pressure turbine 4 through the inlet 5. The steam flow direction regarding the reheat steam inlet 3 of the intermediate-pressure turbine 2 is directed toward the counter-direction of the steam flow direction regarding the main steam inlet 5 of the high-pressure turbine 4. Further, between the intermediate-pressure turbine 2 and the high-pressure turbine 4, an intermediate-pressure dummy part 6 is provided so as to cancel the thrust force developed in the intermediate-pressure turbine 2, and a high-pressure dummy part 7 is also provided so as to cancel the thrust force developed in the high-pressure turbine 4. Further, a space 8 is provided between the intermediate-pressure dummy part 6 and the high-pressure dummy part 7.

As depicted in FIG. 4, in the steam turbine system 03, a part of the steam between the stator blades 44a of the first stator cascade in the high-pressure turbine 4 and the rotor blades 44b of the first rotor cascade in the high-pressure turbine 4 is bled as the cooling steam to be supplied to the intermediate-pressure chamber 4 via the high-pressure dummy part 7 and the intermediate-pressure dummy part 6, the part of the steam as the cooling steam being depressurized after passing through the stator blades 44a of the first stator cascade; thus, the turbine rotor 28 in the intermediate-pressure turbine 2 is cooled by the cooling steam. Incidentally, in FIG. 4, the arrow line of the black thick line marked with the symbol C shows the flow of the cooling steam; a part of the cooling steam is used for cooling the turbine rotor 28, and another part of the cooling steam merges with the steam discharged from the high-pressure turbine 4 so that the confluence steam is re-heated by a re-heater (not shown) and forms a part of reheat steam.

On the other hand, with the progress of the technology in increasing the combustion gas temperature in the field of gas turbines in recent years, the temperature of the main steam that is supplied to the high-pressure turbine as well as the temperature of the reheat steam that is re-heated by the exhaust heat and supplied to the intermediate-pressure turbine has been increased. Further, in order to increase the cycle efficiency of the combined cycle power generating device, the turbine reaction blading has been recently studied and developed; hence, in comparison with the case where conventional impulse blading is used, the temperature of the reheat steam is inclined to be enhanced. Accordingly, in the conventional technology as depicted in FIG. 4, there may be a difficulty that the turbine rotor 28 in the intermediate-pressure turbine 2 is insufficiently cooled.

Further, in relation to the combined cycle power generating device, Patent Reference 1 discloses another technology by which the turbine rotor in the intermediate-pressure turbine can be cooled; namely, Patent Reference 1 discloses a technology regarding a combined cycle power generating device provided with:
a gas turbine plant including a compressor, a combustor and a gas turbine;
a steam turbine plant including a high-pressure turbine, an intermediate-pressure turbine and a low-pressure turbine; and,
a heat recovery steam generator producing the high-pressure steam driving the high-pressure turbine, the intermediate-pressure steam driving the intermediate-pressure turbine, and the low-pressure steam driving the low-pressure turbine, by use of the exhaust gas discharged from the gas turbine,
wherein
a part of the intermediate-pressure steam produced by the heat recovery steam generator is used for cooling the transition pieces of the combustor, the temperature of the part of the steam being higher than the saturation temperature regarding the intermediate-pressure drum in the heat recovery steam generator,
the steam that is heated-up after cooling the transition pieces is recovered and supplied to the intermediate-pressure turbine,
the blades of the gas turbine are cooled by use of the steam bled from the high-pressure turbine;
the steam that is heated-up after cooling the blades of the gas turbine is recovered and supplied to a middle location of the re-heater in the heat recovery steam generator.

### REFERENCES

### Patent References

Patent Reference 1: JP3500020

### SUMMARY OF THE INVENTION

### Subjects To Be Solved

In the technology disclosed by Patent Reference 1 as described above, a part of the intermediate-pressure steam that is produced by the intermediate-pressure drum in the heat recovery steam generator is used for cooling the transition pieces of the combustor; thereby, the temperature of the steam is higher than the saturation temperature regarding the intermediate-pressure drum in the heat recovery steam generator. Further, according to the technology of Patent Reference 1, after the steam that is produced by the intermediate-pressure drum has cooled the transition pieces of the combustor, the steam (the transition piece cooling steam) can cool the turbine rotor in the intermediate-pressure turbine. However, the transition piece cooling steam is supplied to the intermediate-pressure turbine, after the transition piece cooling steam is mixed with the reheat steam supplied to the intermediate-pressure turbine. In view of the reheat steam, the transition piece cooling steam is mixed with the reheat steam before the reheat steam enters the intermediate-pressure turbine. Accordingly, the transition piece cooling steam cools not only the turbine rotor but also the reheat steam. In this way, there arises a difficulty that the thermal efficiency regarding the whole combined power generating device is reduced.

In view of the difficulties in the conventional technology, the present invention aims at providing a combined cycle power generating device in which the turbine rotor in the intermediate-pressure turbine can be efficiently cooled without deteriorating the thermal efficiency regarding the whole combined power generating device.

### Means To Solve the Subjects

In order to achieve the objectives, the present invention discloses a combined cycle power generating device in which exhaust heat of a gas turbine reheats steam which is discharged from a high pressure chamber of a steam turbine so that the reheated steam is supplied to an intermediate-pressure chamber, thereby driving the steam turbine, wherein
cooling steam that has cooled the gas turbine is supplied to the intermediate-pressure chamber via a cooling steam inlet different from an inlet for reheat steam that is reheated by the exhaust heat of the gas turbine, so that the cooling steam is used for cooling purpose,
the temperature of the cooling steam being higher than the temperature of the steam discharged from the high pressure chamber.

According to the above, the cooling steam is supplied to the intermediate-pressure chamber via the cooling steam inlet different from the inlet of the reheat steam; thus, the cooling steam can be supplied to the intermediate-pressure chamber, without cooling the reheat steam.
Further, the temperature of the cooling steam that has cooled the gas turbine is lower than the temperature of the reheat steam; thus, when the cooling steam is supplied to the intermediate-pressure chamber, the turbine rotor in the intermediate-pressure chamber can be efficiently cooled.
Incidentally, the temperature of the steam at the outlet side of the high-pressure chamber is excessively lower than the temperature of the reheat steam; therefore, if the steam at the outlet side of the high-pressure chamber is used as the cooling steam, then the temperature control regarding the intermediate-pressure chamber becomes difficult, because of the great difference between the temperature of the reheat steam and the temperature of the steam at the outlet side of the high-pressure chamber. Hence, it becomes necessary that the temperature of the cooling steam (to be used for cooling the intermediate-pressure chamber) be higher than the temperature of the steam at the outlet side of the high-pressure chamber.

A preferable embodiment of the present invention is the combined cycle power generating device, the intermediate-pressure chamber including, but is not limited to:
an intermediate pressure casing for supporting roots and tips of stator blades of a first stage stator cascade that is placed immediately behind the reheat steam inlet, as well as roots of stator blades of a second stage stator cascade and the following stage stator cascades; and
an intermediate pressure turbine rotor having a plurality of rotor cascades, the intermediate pressure turbine rotor being housed in the intermediate pressure casing,
wherein the cooling steam inlet is communicated to a space between the first stage stator cascade and a first stage rotor cascade, via a gap between the intermediate pressure turbine rotor and the intermediate pressure casing at a location where the intermediate pressure casing supports the stator blades of the first stage stator cascade.
According to the above, after the reheat steam has passed through the first stage stator cascade and the temperature of the reheat steam is reduced to a level of the temperature of the above-described cooling steam, the reheat steam enters the intermediate-pressure chamber; then, the cooling steam enters the intermediate-pressure chamber. Hence, the reheat steam can be supplied to the intermediate-pressure chamber, without being cooled by the cooling steam. Accordingly, the reheat steam can further efficiently produce mechanical work in the intermediate-pressure chamber.

Another preferable embodiment of the present invention is the combined cycle power generating device, wherein
the pressure of the cooling steam is higher than the pressure of the reheat steam;
a dummy part is provided between the intermediate pressure chamber and the high-pressure chamber so as to partition between the chambers; and,
the cooling steam inlet is communicated with the dummy part.
According to the above, the cooling steam also cools the dummy part. Thus, the cooled area can be enlarged.

Another preferable embodiment of the present invention is the combined cycle power generating device, wherein the cooling steam is a transition piece cooling steam that has cooled a combustor of the gas turbine.
In a conventional way, since the transition piece cooling steam is directly mixed with the reheat steam so as to be treated in the following cycle process, the transition piece cooling steam cools the reheat steam so that the thermal efficiency is reduced. According to the above embodiment, however, the transition piece cooling steam is used as the cooling the steam as described above; thus, it becomes unnecessary to mix the transition piece cooling steam with the reheat steam. Therefore, the deterioration of the thermal efficiency can be prevented, the deterioration being attributable to the temperature drop of the reheat steam mixed with the transition piece cooling steam.

### Effects of the Invention

According to the present invention, a combined cycle power generating device can be realized; thereby, the turbine rotor in the intermediate-pressure turbine can be efficiently cooled without deteriorating the thermal efficiency regarding the whole combined power generating device.

### BRIEF DESCRIPTION OF THE DRAWINGS

FIG. 1 shows the diagram regarding the system outline of the combined cycle power generating device according to a first mode of the present invention;

FIG. 2 explains the cooling regarding the turbine rotor in the intermediate-pressure turbine according to the first mode of the present invention;

FIG. 3 explains the cooling regarding the turbine rotor in the intermediate-pressure turbine according to a second mode of the present invention;

FIG. 4 explains the cooling regarding the turbine rotor in the intermediate-pressure turbine according to a conventional technology.

### DETAILED DESCRIPTION OF THE PREFERRED EMBODIMENTS

Hereafter, the present invention will be described in detail with reference to the modes or embodiments shown in the figures. However, the dimensions, materials, shape, the relative placement and so on of a component described in these modes or embodiments shall not be construed as limiting the scope of the invention thereto, unless especially specific mention is made.

### First Mode

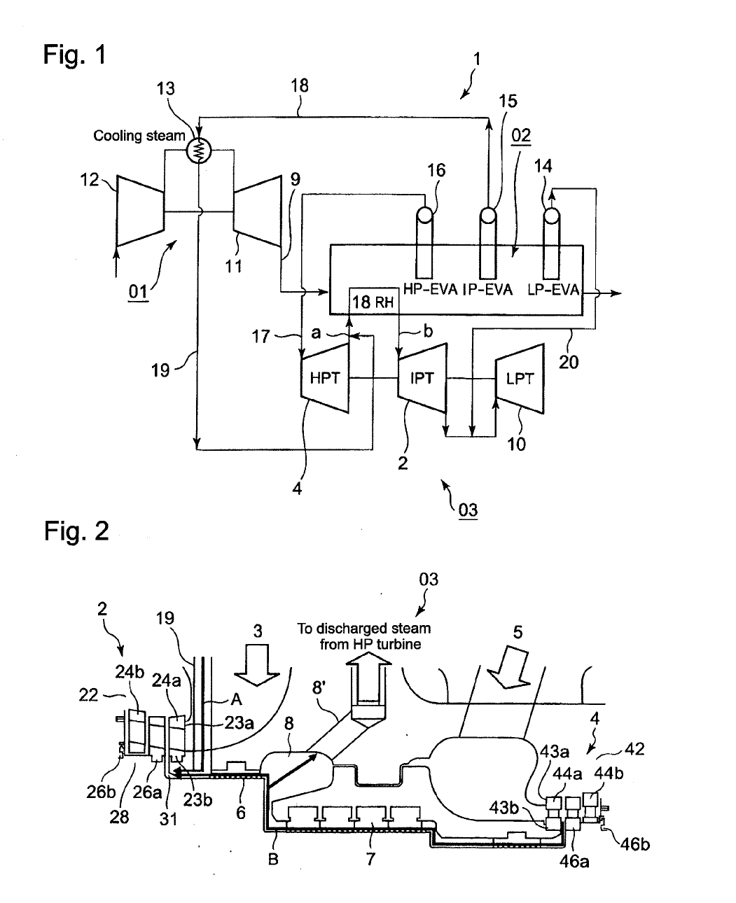

FIG. 1 shows the diagram regarding the system outline of the combined cycle power generating device according to a first mode of the present invention.
The combined cycle power generating device 1 includes a gas turbine (system) 01, a heat recovery steam generator 02, and a steam turbine system 03 that includes a high-pressure turbine 4, an intermediate-pressure turbine and a low-pressure turbine 10.

As shown in FIG. 1, the gas turbine system 01 includes a compressor 12, a combustor 13 and a gas turbine 11; the compressor 12 inhales the atmospheric air and compresses the air to a predetermined pressure level; in the combustor 13, the air compressed by the compressor 12 and fuel are mixed and burnt so that the temperature of the combustion gas reaches a prescribed temperature at the turbine inlet (combustion gas inlet). After having produced mechanical work in the combustor 13, the combustion gas is discharged as the exhaust gas from the gas turbine, and supplied toward the heat recovery steam generator 02 via an exhaust gas duct 9.

Further, the heat recovery steam generator 02 includes a low-pressure drum 14, an intermediate-pressure drum 15 and a high-pressure drum 16; in each drum, superheated steam is generated. The steam generated in the high-pressure drum 16 as the main steam is supplied to the high-pressure turbine 4 through a high-pressure steam pipe 17, and expands so as to produce mechanical work in the high-pressure turbine 4. The steam discharged from the steam outlet of the high-pressure turbine 4 is supplied to a re-heater 18RH so as to be reheated therein: the reheated steam as the reheat steam is supplied to the intermediate-pressure turbine 2.

Further, the steam generated in the intermediate-pressure drum 15 is supplied to the transition pieces of the combustor 13 through a cooling steam pipe 18, and cools the transition pieces; the steam that has cooled the transition pieces of the combustor 13 and is heated-up by the heat exchange to a temperature level higher than the temperature level at the steam outlet the high-pressure turbine 4; and, the heated-up steam is fed to the intermediate-pressure turbine 2 through a cooling steam recovery pipe 19, as described later.

Further, the reheat steam supplied to the intermediate-pressure turbine 2 expands so as to produce mechanical work in the intermediate-pressure turbine 2; then, the steam having produced mechanical work therein is discharged out of the intermediate-pressure turbine 2, and merges with the steam that is generated in the low-pressure drum 14 and fed through a low-pressure steam pipe 20. And, the confluence of the steam is fed to the steam inlet of the low-pressure turbine 10.

The steam supplied to the steam inlet of the low-pressure turbine 10 expands so as to produce mechanical work in the low-pressure turbine 10, the mechanical work being added to the power produced by the generator (not shown); the steam having produced mechanical work in the low-pressure turbine 10 is fed to a condenser (not shown) so as to be condensed into water. Further, the condensed water is pressurized to a prescribed pressure by a pressure pump, and fed to the heat recovery steam generator 02 via a feed water pipe.

In the next place, in relation to the combined cycle power generating device 1 as shown in FIG. 1, the cooling regarding the intermediate-pressure turbine 2 is explained. FIG. 2 explains the cooling regarding the turbine rotor in the intermediate-pressure turbine according to the first mode of the present invention; in addition, FIG. 2 shows the periphery of the steam inlet of the high-pressure turbine as well as the periphery of the steam inlet of the intermediate-pressure turbine regarding the steam turbine system.

As already described based on FIG. 1, the steam turbine system 03 includes a high-pressure turbine 4, an intermediate-pressure turbine 2 and a low-pressure turbine 10.
The intermediate-pressure turbine 2 includes a plurality of stator cascades. A plurality of stator blades 24a forms the first stage stator cascade; a plurality of stator blades 24b forms the second stage stator cascade; a plurality of stator blades 24c forms the third stage stator cascade, and so on. Hereby, the intermediate-pressure turbine 2 further includes an intermediate-pressure turbine casing 22 that supports the roots 23a and tips 23b of the stator blades 24a regarding the first stage stator cascade; in addition, the intermediate-pressure turbine casing 22 supports the roots 23a of the stator blades 24b, 24c, . . . regarding the second stage stator cascade and the following stage stator cascades. The intermediate-pressure turbine 2 further includes a plurality of rotor cascades. A plurality of rotor blades 26a forms the first stage rotor cascade; a plurality of rotor blades 26b forms the second stage rotor cascade; a plurality of rotor blades 26c forms the third stage rotor cascade, . . . , and so on.
On the other hand, the high-pressure turbine 4 includes a plurality of stator cascades. A plurality of stator blades 44a forms the first stage stator cascade; a plurality of stator blades 44b forms the second stage stator cascade; a plurality of stator blades 44c forms the third stage stator cascade, . . . , and so on. Hereby, the high-pressure turbine 4 further includes a high-pressure turbine casing 42 that supports the roots 43a and tips 43b of the stator blades 44a regarding the first stage stator cascade; in addition, the high-pressure turbine casing 42 supports the roots 43a of the stator blades 44b, 44c, . . . regarding the second stage stator cascade and the following stage stator cascades. The high-pressure turbine 4 further includes a plurality of rotor cascades. A plurality of rotor blades 46a forms the first stage rotor cascade; a plurality of rotor blades 46b forms the second stage rotor cascade; a plurality of rotor blades 26c forms the third stage rotor cascade, . . . , and so on.

Further, a reheat steam inlet 3 is provided so that the reheat steam is supplied to the intermediate-pressure turbine 2 through the inlet 3; in addition, a main steam inlet 5 is provided so that the main steam is supplied to the high-pressure turbine 4 through the inlet 5. The steam flow direction regarding the reheat steam inlet 3 of the intermediate-pressure turbine 2 is directed toward the counter-direction of the steam flow direction regarding the main steam inlet 5 of the high-pressure turbine 4. Further, between the intermediate-pressure turbine 2 and the high-pressure turbine 4, an intermediate-pressure dummy part 6 is provided so as to cancel the thrust force developed in the intermediate-pressure turbine 2, and a high-pressure dummy part 7 is also provided so as to cancel the thrust force developed in the high-pressure turbine 4. Further, a space 8 is provided between the intermediate-pressure dummy part 6 and the high-pressure dummy part 7.

In the steam turbine system 03 as depicted in FIG. 2, a communicating passage 31 is provided so as to communicate a location between the stator blades 44a of the first stator cascade in the high-pressure turbine 4 and the rotor blades 44b of the first rotor cascade in the high-pressure turbine 4 to a location between the stator blades 24a of the first stator cascade in the intermediate-pressure turbine 2 and the rotor blades 26a of the first rotor cascade in the intermediate-pressure turbine 2. In this manner, a part of the steam between the stator blades 44a of the first stator cascade in the high-pressure turbine 4 and the rotor blades 44b of the first rotor cascade in the high-pressure turbine 4 is bled as the cooling steam for cooling the turbine rotor 28 in the intermediate-pressure turbine 2, the part of the steam as the cooling steam being depressurized after passing through the stator blades 44a of the first stator cascade. Hereby, the bled steam is supplied to the location between the stator blades 24a of the first stator cascade in the intermediate-pressure turbine 2 and the rotor blades 26a of the first rotor cascade in the intermediate-pressure turbine 2, via the communicating passage 31, so as to cool the turbine rotor 28 in the intermediate-pressure turbine 2. Incidentally, in FIG. 2, the arrow line of the black thick line marked with the symbol B shows the flow of the cooling steam from the high-pressure turbine 4. Further, a part of the cooling steam is used for cooling the turbine rotor 28 in the intermediate-pressure turbine 2; another part of the cooling steam merges with the steam discharged from the high-pressure turbine 4, via a space 8 and a pipe line (a steam passage) 8′ that merges with a steam pipe line depicted with a symbol a in FIG. 1, the passage 8′ merging with the steam flow that is discharged out of from the high-pressure turbine 4. And the confluence steam is reheated so as to form a part of the reheat steam.

Further, a specific configuration of the present invention is that the cooling steam (hereafter also called the transition piece cooling steam) that has been heated-up by cooling he transition pieces of the combustor 6 13 streams through the cooling steam recovery pipe 19, and the cooling steam recovery pipe 19 merges with the communicating passage 31, at the location between the intermediate-pressure dummy part 6 and the intermediate-pressure turbine 2. In this way, the transition piece cooling steam that has cooled the transition pieces of the combustor 13 in the gas turbine 01 is supplied to the location between the stator blades 24a of the first stator cascade and the rotor blades 26a of the first rotator cascade in the intermediate-pressure turbine 2; thus, the transition piece cooling steam cools the turbine rotor 28 in the intermediate-pressure turbine 2. Incidentally, in FIG. 2, the arrow line of the black thick line marked with the symbol A shows the flow of the transition piece cooling steam.

According to the first mode of the present invention, in addition to the cooling steam streaming from the high-pressure turbine 4 to the intermediate-pressure turbine 2 as depicted by the steam flow marked with the symbol B in FIG. 2, the transition piece cooling steam cools the turbine rotor 28 in the intermediate-pressure turbine 2 as depicted by the steam flow marked with the symbol A in FIG. 2. The temperature of the transition piece cooling steam is lower than the temperature of the cooling steam streaming through the flow line marked with the symbol B in FIG. 2; accordingly, the cooling effect regarding the turbine rotor 28 in the intermediate-pressure turbine 2 can be enhanced by use of the transition piece cooling steam.
Incidentally, on the other hand, it can be considered that the steam on the outlet side of the high-pressure turbine 4 is made use of so as to cool the turbine rotor 28, in view of the steam process regarding the combined cycle power generating device; thereby, the temperature of the steam on the outlet side of the high-pressure turbine 4 is lower than the temperature of the transition piece cooling steam. However, the temperature of the steam on the outlet side of the high-pressure turbine 4 is excessively lower than the temperature of the transition piece cooling steam and the cooling effect is surplus; hence, when the steam on the outlet side of the high-pressure turbine is used for cooling the turbine rotor 28 and the intermediate-pressure turbine 2, the temperature control becomes difficult. Therefore, it is preferable to use the steam of which the temperature is higher than the temperature of the steam on the outlet side of the high-pressure turbine 4 and lower than the temperature of the steam streaming through the flow line marked with the symbol B in FIG. 2; and, the transition piece cooling steam satisfies this preferable condition, and is optimal as the cooling steam that cools the part in question.

Further, toward the location between the stator blades 24a of the first stator cascade in the intermediate-pressure turbine 2 and the rotor blades 26a of the first rotor cascade in the intermediate-pressure turbine 2, the steam streaming through the flow line marked with the symbol B as well as the transition piece cooling steam is supplied. After both the steam cools the part in question, both the steam (confluence steam) can be fed to the intermediate-pressure turbine 2, via the re-heater, without reducing the temperature of the reheat steam.
In other words, the turbine rotor in the intermediate-pressure turbine can be efficiently cooled, without deteriorating the whole thermal cycle.

### Second Mode

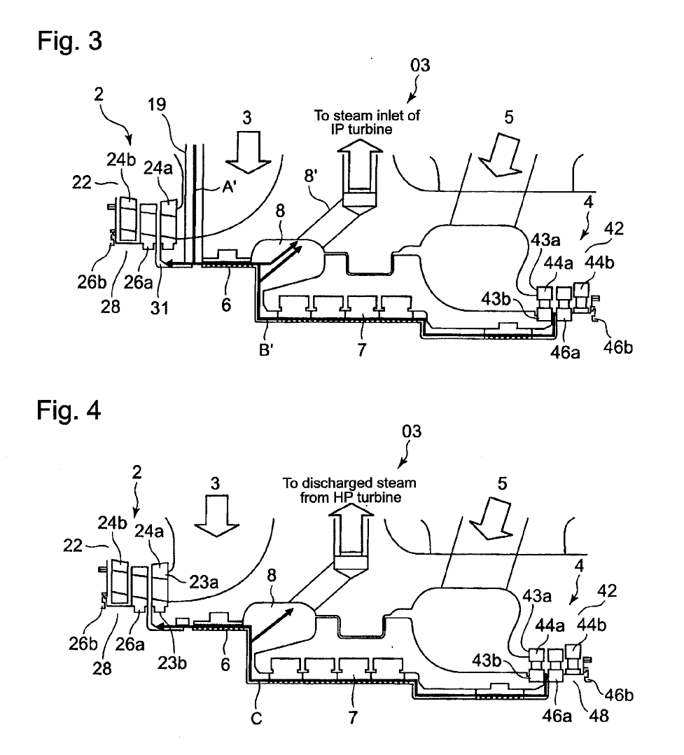

FIG. 3 explains the cooling regarding the turbine rotor in the intermediate-pressure turbine according to a second mode of the present invention; FIG. 3 shows the periphery of the steam inlet of the high-pressure turbine as well as the periphery of the steam inlet of the intermediate-pressure turbine regarding the steam turbine in the combined cycle power generating device.
Incidentally, the same components in FIG. 3 as in FIG. 2 are given common numerals or symbols and, explanation repetitions regarding the same components are omitted. Further, in this second mode, the system diagram regarding the whole combined cycle power generating device is the same as that in FIG. 1 of the first mode, except the steam flow lines that appear in the space 8; thus, the drawing and the explanation are omitted on the premise that the explanation is given by the aid of FIG. 1.

In FIG. 3, the pipe line 8′ is merged with a part b′ of FIG. 1.
The pressure of the steam in the space 8 is almost the same as the pressure of the steam at the counter-end side of the pipe line 8′. Thus, in FIG. 3, the pressure of the steam in the space 8 is almost the same as the pressure of the steam at the inlet side of the intermediate-pressure turbine 2, the pressure of the steam in the space 8 being lower than the pressure of the transition piece cooling steam.
Hence, as shown by the arrow line marked with the symbol A′ in FIG. 3 regarding the second mode, a part of the transition piece cooling steam streams toward the turbine rotor 28 in the intermediate-pressure turbine 2 so as to cool the turbine rotor 28; and, another part of the transition piece cooling steam streams toward the inlet side (the line part b in FIG. 1) of the intermediate-pressure turbine 2, via intermediate-pressure dummy part 6 and the space 8, so as to merge with the reheat steam. Thereby, as shown by the arrow line marked with the symbol B′ in FIG. 3, the cooling steam from the high-pressure turbine 4 wholly streams toward the inlet side (the line part b in FIG. 1) of the intermediate-pressure turbine 2, via the space 8 and the pipe line 8′, so as to merge with the reheat steam.

According to the above-described second mode of the present invention, in addition to the same effect as by the first mode, the intermediate-pressure dummy part 6 can be also cooled by use of the transition piece cooling steam. Thus, the cooled area can be enlarged.

### INDUSTRIAL APPLICABILITY

The present disclosure can be applicable to the combined cycle power generating device in which the turbine rotor in the intermediate-pressure turbine can be efficiently cooled, without deteriorating the whole thermal cycle.

1-4. (canceled)

5. A combined cycle power generating device in which exhaust heat of a gas turbine reheats steam which is discharged from a high pressure chamber of a steam turbine so that the reheated steam is supplied to an intermediate-pressure chamber, thereby driving the steam turbine, wherein
cooling steam that has cooled the gas turbine is supplied to the intermediate-pressure chamber via a cooling steam inlet different from an inlet for reheat steam that is reheated by the exhaust heat of the gas turbine, so that the cooling steam is used for cooling purpose, the temperature of the cooling steam being higher than the temperature of the steam discharged from the high pressure chamber.

6. The combined cycle power generating device according to claim 5, the intermediate pressure chamber comprising:
an intermediate pressure casing for supporting roots and tips of stator blades of a first stage stator cascade that is placed immediately behind the reheat steam inlet, as well as roots of stator blades of a second stage stator cascade and the following stage stator cascades; and
an intermediate pressure turbine rotor having a plurality of rotor cascades, the intermediate pressure turbine rotor being housed in the intermediate pressure casing,
wherein the cooling steam inlet is communicated to a space between the first stage stator cascade and a first stage rotor cascade, via a gap between the intermediate pressure turbine rotor and the intermediate pressure casing at a location where the intermediate pressure casing supports the stator blades of the first stage stator cascade.

7. The combined cycle power generating device according to claim 5, wherein
the pressure of the cooling steam is higher than the pressure of the reheat steam;
a dummy part is provided between the intermediate pressure chamber and the high-pressure chamber so as to partition between the chambers; and,
the cooling steam inlet is communicated with the dummy part.

8. The combined cycle power generating device according to claim 6, wherein
the pressure of the cooling steam is higher than the pressure of the reheat steam;
a dummy part is provided between the intermediate pressure chamber and the high-pressure chamber so as to partition between the chambers; and,
the cooling steam inlet is communicated with the dummy part.

9. The combined cycle power generating device according to claim 5, wherein the cooling steam is a transition piece cooling steam that has cooled a combustor of the gas turbine.

10. The combined cycle power generating device according to claim 6, wherein the cooling steam is a transition piece cooling steam that has cooled a combustor of the gas turbine.

11. The combined cycle power generating device according to claim 7, wherein the cooling steam is a transition piece cooling steam that has cooled a combustor of the gas turbine.

12. The combined cycle power generating device according to claim 8, wherein the cooling steam is a transition piece cooling steam that has cooled a combustor of the gas turbine.
